(19) United States
(12) Patent Application Publication
(10) Pub. No.: US 2022/0255137 A1
(43) Pub. Date: Aug. 11, 2022

(54) CONDUCTIVE 2D METAL-ORGANIC FRAMEWORK FOR AQUEOUS RECHARGEABLE BATTERY CATHODES

(71) Applicants: Northwestern University, Evanston, IL (US); King Abdulaziz City for Science and Technology (KACST}, Riyadh (SA)

(72) Inventors: James Fraser Stoddart, Evanston, IL (US); Mirkin A. Chad, Wilmetie, IL (US); Woo Nam Kwan, Evanston, IL (US); Park S. Sarah, Evanston, IL (US)

(21) Appl. No.: 17/597,507

(22) PCT Filed: Jul. 10, 2020
(86) PCT No.: PCT/US20/41615

§ 371 Date: Jan. 10, 2022

Related U.S. Application Data
(60) Provisional application No. 62/872,418, filed on Jul. 10, 2019.

(51) Int. Cl. H01M 10/38; H01M 4/58; H01M 4/42; H01M 4/04

(52) U.S. Cl. CPC H01M 10/38; H01M 4/5815; H01M 2004/027; H01M 4/42; H01M 4/0404; H01M 4/5825

(57) ABSTRACT

Disclosed herein are batteries comprising a M₃(C₆(C₆H₂X₂)₃)₂ active material, wherein M is a late transition metal and X is selected from O, S, or NH, and an aqueous electrolyte comprising a multivalent cationic charge carrier. Also disclosed are methods of making the same.

### CROSS-REFERENCE TO RELATED APPLICATIONS

This application claims benefit of priority to U.S. Provisional Application No. 62/872,418, filed 10 Jul. 2019, the content of which is incorporated herein by reference it its entirety.

### STATEMENT REGARDING FEDERALLY SPONSORED RESEARCH

This invention was made with government support under CHE-170988 awarded by National Science Foundation and FA9550-17-1-0348 awarded by the Air Force Office of Scientific Research. The government has certain rights in the invention.

### FIELD OF THE INVENTION

The disclosed technology is generally directed to aqueous rechargeable batteries. More particularly the technology is directed to aqueous rechargeable batteries having a cathode composed of conductive 2D metal-organic frameworks.

### BACKGROUND OF THE INVENTION

One of the most suitable candidates for energy storage is lithium-ion batteries (LIBs), and these provide high performance in mobile devices such as cellular phones and laptops. However, their utilization in large-scale applications¹⁻³ such as electric vehicles is inhibited by high material costs and safety concerns⁴⁻⁵. As a result, there is a need for new batteries and battery components such as greener electrode materials and aqueous electrolytes⁴⁻⁵.

Rechargeable aqueous batteries, such as rechargeable aqueous zinc batteries, have attracted⁶⁻¹¹ considerable attention for use in large-scale energy storage systems due to the large theoretical capacity, low toxicity, and, potentially, low material costs. Furthermore, aqueous batteries operate in aqueous electrolytes, potentially gaining additional advantages related to safety, cost, and rate performance.

Despite these advantages, rechargeable ZBs have several obstacles that need to be resolved before replacing LIBs in terms of electrochemical performance¹³⁻¹⁴. Development of a new high-performance cathode is crucial for the commercialization of aqueous batteries. α-MnO₂ with a 2×2 tunnel structure was used as a rechargeable ZB cathode, in which the large tunnels facilitated Zn²⁺ ion diffusion within the host structure¹², providing high capacity and rate performance. However, these materials present low cyclability that is attributed to an unstable phase transition from a tunneled to a layered structure with simultaneous Mn²⁺ dissolution during the discharge-charge process¹³⁻¹⁴. Vanadium-based cathodes^{6,15} also provide high capacity and rate performance, although the high cost of vanadium could prohibit large-scale energy storage applications. Recently, organic-based cathodes such as quinone derivatives have been investigated because these are low cost, ubiquitous, and lightweight compared to inorganic cathodes^{11,16}. However, dissolution issues during battery cycling inhibit the use of quinone derivatives in ZBs. To improve the stability of the quinone-based materials, polymerization¹⁷, carbon composites¹⁸, and synthesizing as an extended analogue¹¹ have been tried; however, the dissolution issues of organic cathodes are still a drawback. In consideration of these difficulties, the development of new materials for aqueous battery cathodes is necessary.

### BRIEF SUMMARY OF THE INVENTION

Disclosed herein are conductive 2D metal-organic frameworks (MOFs) for aqueous rechargeable battery cathodes. The cathode may comprise a M₃(C₆(C₆H₂X₂)₃)₂ active material. M may be selected from a late transition metal. Suitably, M may be selected from Cu, Co, Ni, or Pt. X may be selected from O, S, or NH. The battery further comprises an anode and an aqueous electrolyte. The aqueous electrolyte may comprise a multivalent cationic charge carrier. Suitably, the multivalent cationic charge carrier may be selected from Zn²⁺, Mg²⁺, Ca²⁺, Sr²⁺, Ba²⁺, or Al³.

Another aspect of the invention is a method for preparing any of the batteries described herein. The method may comprise providing a cathode comprising a M₃(C₆(C₆H₂X₂)₃)₂ active material, providing an aqueous electrolyte, and assembling the cathode, the aqueous electrolyte, and an anode. The active material may be any of the active materials described herein and the aqueous electrolyte may be any of the aqueous electrolytes described herein. In some embodiments, providing the cathode comprises preparing a slurry comprising the active material, depositing the slurry onto a substrate, and drying slurry.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A schematically illustrates of the rechargeable Zn-2D MOF cell.

FIG. 1B shows the structure of a hexagonal, 2D MOF, M₃(C₆(C₆H₂X₂)₃)₂ active material viewed down the c-axis. For Cu₃(HHTP)₂, M=Cu and X=O. The H atoms are omitted for the sake of clarity.

FIG. 1C illustrates the expected redox process in the coordination unit of Cu₃(HHTP)₂.

FIGS. 2A-2G illustrate the 2D chemical structure and structural analysis of Cu₃(HHTP)₂.

FIG. 2A shows Rietveld refinement of PXRD patterns as shown for the observed measurement (circle), calculated (trace through the circles), difference between observed and calculated (bottom trace), and Bragg position (vertical bar). FIG. 2B shows a FE-SEM image of Cu₃(HHTP)₂. FIG. 2C shows a HR-TEM image of Cu₃(HHTP)₂ at a low resolution. FIG. 2D shows a HR-TEM image of Cu₃(HHTP)₂ along [001] indicating a hexagonal pore packing with d₁₀₀=2.0 nm. FIGS. 2E and 2G show HR-TEM images at (FIG. 2E) low and (FIG. 2G) high resolution along the [010] direction. FIG. 2F shows an FFT pattern of the region highlighted by a square in FIG. 2E.

FIGS. 3A-3D shows electrochemical performance of Cu₃(HHTP)₂. FIGS. 3A-3B show discharge-charge voltage profiles of Cu₃(HHTP)₂ at (FIG. 3A) 50 mA g⁻¹ and (FIG. 3B) various current densities. FIGS. 3C-3D show cycling performance of Cu₃(HHTP)₂ at a current densities of (FIG. 3C) 500 mA g⁻¹ and (FIG. 3D) 4000 mA g⁻¹.

FIGS. 4A-4C show electronic states analysis during discharge-charge. FIGS. 4A-4C show ex situ XPS spectra of (FIG. 4A) Zn 2p [pristine (bottom), fully discharged (middle), and fully charge (top)], (FIG. 4B) O 1s, and (FIG. 4C) Cu 2p. In FIG. 4B, the position of the maxima for the benzoid trace is at a higher binding energy than the quinoid trace.

FIGS. 5A-5F show structure analysis during discharge-charge. FIG. 5A shows XRD patterns of the Cu₃(HHTP)₂ electrode in the pristine (bottom), fully discharged (second to bottom), fully charged (second to top), and 500^{th} fully charged (top) states at a rate of 4000 mA g⁻¹. FIG. 5B shows scanning transmission electron microscopy (STEM) image of the fully discharged Cu₃(HHTP)₂ alongside its EDX elemental mapping with respect to C, Cu, O, and Zn, suggesting uniform Zn insertion over the electrode. FIG. 5C shows an HR-TEM image of discharged Cu₃(HHTP)₂ viewed down the [010] zone axis. An inset in FIG. 5C shows a magnified area depicting the (100) plane. FIG. 5D shows measurements of the (100) interplanar distances from the white boxed area in c indicate the average d₁₀₀=1.87 nm. FIGS. 5E-5F show SAD patterns from Cu₃(HHTP)₂ at (FIG. 5E) pristine and (FIG. 5F) discharged states used to confirm the interplanar distances of (100). The arrows and scale bar indicate the [100] direction and 2 l/nm, respectively.

FIG. 6 shows a cyclic voltammogram of Cu₃(HHTP)₂. Cyclic voltammetry (CV) was performed using coin-type cell, two-electrode configuration with active electrode composed of Cu₃(HHTP)₂:acetylene black:PVDF=6:2:2.

FIG. 7 shows cycle performance of Cu₃(HHTP)₂ at a current density of 50 mA

FIG. 8 shows a TEM image of Cu₃(HHTP)₂ pristine at low magnification.

FIG. 9A-9B show (FIG. 9A) a SEM image of Cu₃(HHTP)₂ powder and (FIG. 9B) EDX spectrum for the selected area in FIG. 9A.

FIGS. 10A-10C show ex situ XPS survey spectra of Cu₃(HHTP)₂ at (FIG. 10A) pristine, (FIG. 10B) discharged, and (FIG. 10C) charged electrodes.

FIGS. 11A-11B show SEM Images of (FIG. 11A) pristine and (FIG. 11B) discharged electrode composed of Cu₃(HHTP)₂:acetylene black:PVDF=6:2:2.

FIGS. 11C-11D show EDX spectra for (FIG. 11C) the pristine electrode in the selected area in FIG. 11A and (FIG. 11D) the discharged electrode in the selected area in FIG. 11B.

### DETAILED DESCRIPTION OF THE INVENTION

Disclosed herein are conductive 2D metal-organic frameworks (MOFs) for aqueous rechargeable battery cathodes. The large pores and high electrical conductivity provide dramatically increased rate performance and cyclability compared to classical organic-based materials. The conductive 2D MOFs utilize both metal nodes and quinoids as redox active sites, increasing the specific capacity of the material. These materials allow for the insertion and extraction of multivalent cationic charge carriers from an aqueous solvent, thereby allowing for the preparation of high performance aqueous rechargeable batteries.

Conductive MOFs are excellent platforms for resolving dissolution issues related to organic-based cathodes. “Metal-organic frameworks” or “MOFs” are a class of compounds consisting of metal ions or clusters coordinated to organic ligands, which are sometimes referred to as linkers or struts, to form one-, two- or three-dimensional structures. In MOFs, active organic molecules may be immobilized by metal-ligand coordinate covalent bonds. This allows for the preparation of compounds having a porous structure and high electrical conductivity that are favorable to ion and electron transport in the framework. As a result, these materials may have high rate capability and cyclability.

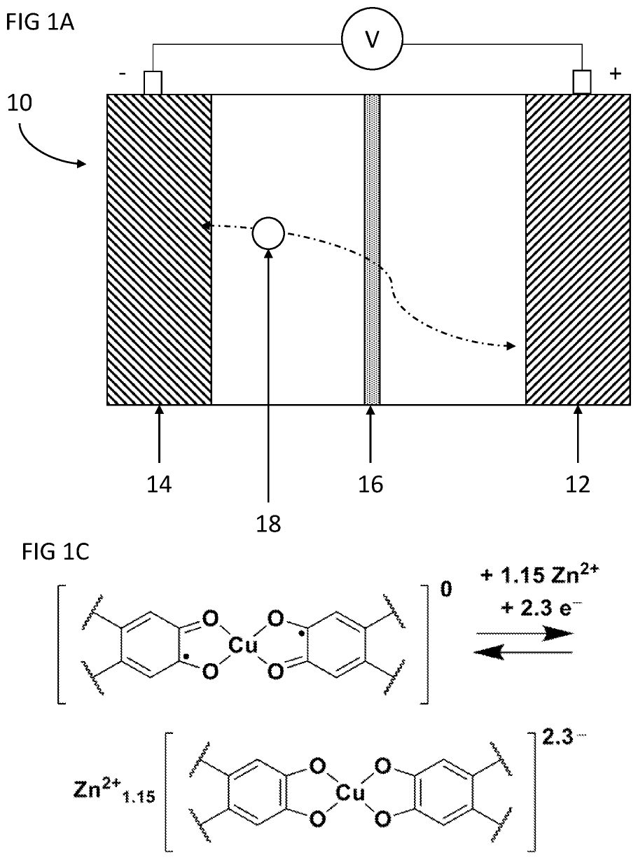

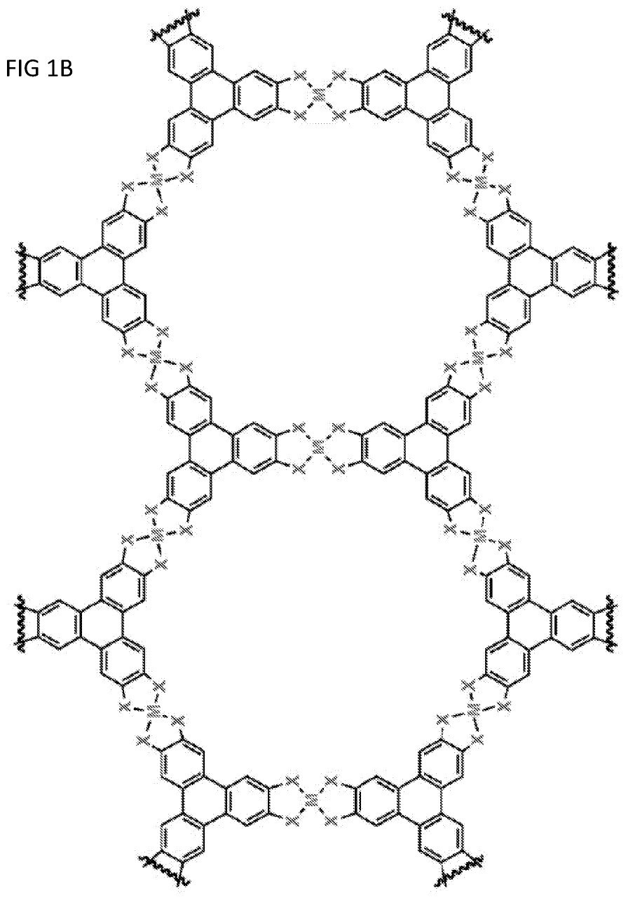

Batteries may be prepared from the conductive MOFs described herein. Referring to FIG. 1A, the battery 10 is comprises of a cathode 12, anode 14, and an electrolyte disposed within the battery 10 and allowing for electrochemical communication between the cathode 12 and the anode 14. The electrolyte may comprise an aqueous electrolyte having a multivalent cationic charge carrier 18 allowing for electrochemical communication between the cathode and anode. The battery may further comprise a separator 16.

An advantage of the present technology is the use of multivalent charge carriers for the preparation of the rechargeable batteries described herein. Suitably, the multivalent cationic charge carrier may be selected from Zn²⁺, Mg²⁺, Ca²⁺, Sr²⁺, Ba²⁺, Al³⁺, and the like. Suitable electrolytes include, without limitation, Zn(CF₃SO₃)₂, Zn(CH₃SO₃)₂, ZnSO₄.xH₂O (x=0-7), Zn(NO₃)₂.xH₂O (x=0-6), Zn(TFSI)₂, Mg(CF₃SO₃)₂, Mg(CH₃SO₃)₂, MgSO₄.xH₂O (x=0-7), Mg(TFSI)₂, Ca(NO₃)₂.xH₂O (x=0-4), CaSO₄.xH₂O (x=0-2), BaSO₄.xH₂O (x=0-4), Ba(NO₃)₂.xH₂O (x=0-4), SrSO₄.xH₂O (x=0-4), Sr(NO₃)₂.xH₂O (x=0-4), Al₂(SO₄)₃.xH₂O (x=0-18) or Al(NO₃)₃.xH₂O (x=0-9). Although monovalent charge carriers, such as Li⁺ and Na⁺, can be used, the performance of multivalent charge carriers is superior for battery applications. As demonstrated in the Examples that follow, multivalent cationic charge carriers are accommodated in the large pores of the conductive 2D MOF, thus enabling long-term stability while cycling at a high rate.

Conductive 2D metal-organic frameworks (“conductive 2D MOFs”) are planar MOFs comprising a metal ion and an organic linker that allow for through-bond charge transport because of the formation of extended 2D π-conjugation. Materials of this sort are reminiscent of graphite, but conductive 2D MOFs may be tailored for a desired application by selecting, for example, the metal ion and/or organic linker. Monolayers of these materials possess dispersed valence and conduction bands, indicating band transport and thus high charge mobility within the 2D sheets. Materials synthesized using this approach are the most conductive MOFs known.

Conductive 2D MOFs exhibit stacked honeycomb lattices and may be prepared from planar aromatic ligands with ortho-disubstituted donor atoms X that define square-planar coordination environments with a variety of metal nodes M²⁶. The conductive 2D MOF may have an empirical formula of M₃(C₆(C₆H₂X₂)₃)₂. Suitably the planar aromatic ligand, C₆(C₆H₂X₂)₃, is a triphenylene ligand as shown in FIG. 1B. Each of the ligands is expected to be oxidized to achieve charge balance with the M²⁺ centers (see, e.g., FIG. 1C). Suitable donor atoms or groups X include, without limitation, O, S, and NH and the metal nodes may include late-transition metals such as Co, Ni, Cu, Rh, Pd, Ag, Ir, Pt, or Au²⁶. Ligand oxidation is likely important for increasing the charge density and implicitly the conductivity of these materials. In some embodiments, M is selected from Cu, Co, Ni, or Pt. In some embodiments, X is O and M is selected from Cu, Co, or Ni. In some case, X is O and M is Cu. In some embodiments, X is S and M is selected from Co or Pt. In some embodiments, X is NH and M is selected from Cu or Ni.

The hexagonal pores defined by triphenylene-based lattices are on the order of around 2 nm, although the stacking mode of the 2D sheets can vary. In some cases, the sheets exhibit an eclipsed or slipped-parallel stacking structure, giving extended 1D pores; in other cases, the sheets stack in a staggered fashion and define smaller 1D pores. An empirical trend suggests that 2D lattices made from metal-N or metal-O linkages tend to exhibit eclipsed or slipped-parallel structures, while S donor ligands are more likely to give staggered structures. Clearly, although the intra-sheet transport is expected to dominate the electrical properties of these materials, the stacking arrangement affects electrical transport between the 2D sheets.

Hmadeh et al. reported²⁷ a series of metal catecholate frameworks, made by reaction of hexahydroxytriphenylene (H₆HHTP) with Co^{II} or Ni^{II} salts, which were shown to contain extended 2D sheets layered between molecular metal HHTP complexes (FIG. 1B; X=O; M=Co, Ni). The structures of the Co and Ni 2D catecholate MOFs were established by X-ray crystallography and high resolution transmission electron microscopy (HR-TEM). Both the Co- and Ni-based MOFs display permanent porosity, with BET surface areas of 490 and 425 m² g⁻¹, respectively. Single crystals of a related material synthesized from Cu²⁺ and H₆HHTP exhibit a conductivity of 0.2 Scm⁻¹ (four-probe) at room temperature. Miner et al. reported³³ the bulk conductivity for Ni₃(HHTP)₂ and Co₃(HHTP)₂ as 6×10'S/cm and 2×10⁻³ S/cm, respectively. However, powder X-ray diffraction (PXRD) analysis showed that the CuHHTP material is not isostructural with the Co and Ni-based MOFs, and the structure was not assigned.

Several examples of metal dithiolene 2D MOFs have also been reported²⁸ based on hexathiotriphenylene (H₆HTTP). Cui et al. reported²⁹ a related 2D MOF prepared from H₆HTTP and PtCl₂, which also displays a staggered stacking of 2D sheets (FIG. 1B; X=S; M=Pt). The as-synthesized framework was anionic, with charge-balancing Na⁺ cations, suggesting that the ligands were not oxidized sufficiently to afford a neutral framework. However, the anionic MOF could be oxidized to a neutral material with I₂. Upon evacuation, the neutral Pt₃(HTTP)₂ framework exhibits a BET surface area of 391 m² g⁻¹. The bulk conductivity (pressed pellet, two-probe) of both the as-synthesized and the 12-doped samples was found to be on the order of 10⁻⁶ Scm⁻¹ at room temperature. This conductivity is much lower than those observed for materials in this class; measurements of single sheets or flakes of these materials could reveal whether the low conductivity is due to grain boundaries in the polycrystalline pellet or is an intrinsic property of the Pt MOFs. MOFs made from Co^{II} with H₆HTTP as well as from Ni^{II} with H₆HTTP have been reported²⁶.

Conductive 2D MOFs made from nitrogen-based ligands may also be prepared. Sheberla et al. reported³⁰ that reaction of NiCl₂ with hexaaminotriphenylene (H₆HATP) in ammoniacal water leads to the isolation of Ni₃(HITP)₂ (HITP=hexaiminotriphenylene; FIG. 1B; X=NH; M=Ni), in which 2D honeycomb sheets stack in a slipped-parallel arrangement. Polycrystalline films of Ni₃(HITP)₂ grown on a quartz substrate displayed a conductivity of 40 Scm⁻¹ (four-probe, van der Pauw) at room temperature, while pellets of the same material displayed a bulk conductivity of 2 Scm⁻¹ (two-probe). The isostructural material made from Cu^{II}, Cu₃(HITP)₂ (FIG. 1B; X=NH, M=Cu), displayed similar electrical properties, with a room temperature bulk conductivity of 0.2 Scm⁻¹ (two-probe)³¹.

In addition to the conductive 2D MOF, the cathode may further comprise a binder, an electron-conducting material, a current collector, or any combination thereof. In some embodiments, the conductive 2D MOF is 1-90 wt % (e.g., 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or any ranges therebetween) of the cathodic material. In some embodiments, the conductive 2D MOF is 5-85 wt %, 10-80 wt %, 20-80 wt %, 40-70 wt %, etc. of the cathode material.

In some embodiments, the binder material comprises a polymer selected from the group consisting of: styrene-butadiene rubber (SBR); polyvinylidene fluoride (PVDF); polytetrafluoroethylene (PTFE); polyacrylic acid (PAA); copolymer of tetrafluoroethylene, hexafluoropropylene, and vinylidene fluoride; copolymer of hexafluoropropylene and vinylidene fluoride; copolymer of tetrafluoroethylene and perfluorinated vinyl ether; methyl cellulose; carboxymethyl cellulose; hydroxymethyl cellulose; hydroxyethyl cellulose; hydroxypropylcellulose; carboxymethylhydroxyethyl cellulose; nitrocellulose; colloidal silica; and combinations thereof. In some embodiments, binder material comprises PVDF. In some embodiments, the binder material is 1-25 wt % (e.g., 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 20 wt %, 25 wt %, or any ranges therebetween) of the cathodic material. In some embodiments, the binder material is 5-15 wt % of the cathode material.

In some embodiments, the electron-conducting material is a carbon or graphitic material. In some embodiments, the carbon or graphitic material is selected from the list consisting of: a graphite, a carbon black, a graphene, and a carbon nanotube. In some embodiments, the carbon or graphitic material is a graphite selected from the group consisting of: graphite worms, exfoliated graphite flakes, and expanded graphite. In some embodiments, the carbon or graphitic material is chemically-etched or expanded soft carbon, chemically-etched or expanded hard carbon, or exfoliated activated carbon. In some embodiments, the carbon or graphitic material is a carbon black selected from the group consisting of: acetylene black, ketjen black, channel black, furnace black, lamp black thermal black, chemically-etched or expanded carbon black, and combinations thereof. In some embodiments, the carbon or graphitic material is a carbon nanotube selected from the group consisting of: chemically-etched multi-walled carbon nanotube, nitrogen-doped carbon nanotube, boron-doped carbon nanotube, chemically-doped carbonnanotube, ion-implanted carbon nanotube, and combinations thereof. In some embodiments, the electron-conducting additive comprises carbon black. In some embodiments, the electron-conducting additive is 1-99 wt % (e.g., 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 91 wt %, 92 wt %, 93 wt %, 94 wt %, 95 wt %, 96 wt %, 97 wt %, 98 wt %, 99 wt %, or any ranges therebetween) of the cathode material. In some embodiments, the electron-conducting material is 5-85 wt % of the cathode material.

In some embodiments, the cathodic material comprising the active materials and, optionally, the binder and electron-conducting material is present as a slurry and further comprises a solvent. These slurry materials may be used to prepare the cathodes. In some embodiments, the slurry comprises a solid content of 40-80% 40 wt %, 45 wt %, 50 wt %, 55 wt %, 60 wt %, 65 wt %, 70 wt %, 75 wt %, 80 wt %, or any ranges therebetween). In some embodiments, the solvent comprises N-methyl-pyrrolidone (NMP) or deionized water (DI water). The slurry may be dried to prepare the cathode. In some embodiments, the slurry is dried above room temperature (e.g., above 40° C., 50° C., 60° C., 70° C., 80° C., 90° C., 100° C., 110° C., 120° C., 130° C., 140° C., 150° C., or any temperature range therebetween) and/or under reduced pressure (e.g., below atmospheric pressure or under vacuum).

In some embodiments, a cathode further comprises substrate such as a substrate, such as a foil. In some embodiments, the foil substrate is a stainless steel substrate. In some embodiments, a slurry comprising the active is coated onto the foil substrate and dried. In certain embodiments, the substrate is a current collector.

The battery may further comprise an anode. The anode should be selected to have an active material matched to the multivalent charge carrier. For example, an electrolyte comprising Zn²⁺ may be made of Zn-based material such as metallic Zn or a Zn alloy. The anode is the metallic Zn or may also comprise a binder material; an electron-conducting material; and a substrate. In some embodiments, an anode further comprises a solvent. In some embodiments, the binder material, electron-conducting additive, and/or solvent of the anode are selected from the binder materials, electron-conducting additives, and/or solvents described herein for use in cathodes.

In some embodiments, a battery further comprises a separator. In some embodiments, the separator comprises a filter paper, cellulose, polypropylene (PP), polyethylene (PE), or a combination of layers thereof.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Herein, we demonstrate the utilization of two-dimensional (2D) conductive MOF as a cathode material for a rechargeable aqueous battery using Cu₃(HHTP)₂ (HHTP=(2,3,6,7,10,11-hexahydroxytriphenylene)²⁷ as the cathode material for rechargeable aqueous ZBs (FIGS. 1A and 1B). High bulk electrical conductivity (0.01 S/cm, two-point probe, pellet)²⁷ and large pores (˜2 nm) can facilitate electron and Zn²⁺ ion transport to active sites (FIG. 1B). Especially, we estimate that the redox activity of quinoid, while Zn²⁺ insertion, would promote the performance of the cathode (FIG. 1C). From these unique properties, Cu₃(HHTP)₂ showed redox switching at 1.06 V and 0.88 V vs Zn/Zn²⁺ with a highest reversible capacity of 228 mAh g⁻¹ at 50 mA g⁻¹ among those of other MOF-based cathodes for ZBs.

Materials and Methods

Materials. All commercially available reagents and solvents were purchased from Sigma Aldrich and used as received without further purification. Zn film, SUS film, and coin cells obtained from Goodfellow and Pred Materials, respectively. Cu₃(HHTP)₂ was prepared according to a previous reported procedure,²⁷ washed with H₂O and Me₂CO respectively, and dried in air.

Characterization. The morphology of powder and elementary analysis was carried out through field-emission scanning electron microscopy (FE-SEM, Hitachi S-4800) with implemented energy-dispersive X-ray spectroscopy (EDS). X-Ray diffraction (XRD, STOE STADI-P) with Cu-Kα1 radiation was measured through transmission geometry for crystal structure analysis by scanning in the 20 range of 2°-90° with scan steps of 0.015°. For the characterization of Cu₃(HHTP)₂ at different charge and discharge states, the cells were opened and rinsed with DI water inside a glove-box. The oxidation states of electrodes were analyzed by X-Ray photoelectron spectroscopy (XPS, Thermo scientific ESCALAB 250Xi).

Transmission electron microscopy (TEM). Pristine and discharged Cu₃(HHTP)₂ MOF samples were dispersed in EtOH and further drop-casted on lacey carbon Mo-based TEM grids. HR-TEM was performed using a JEOL Grand ARM operated at 300 kV. Data were collected using a Gatan K3-IS direct electron detector. In order to avoid sample degradation under electron beam, images were collected at a dose rate below 20 e⁻/px/s. For selected area diffraction (SAD), the electron beam was spread out and with data acquired at low magnification to avoid sample damage. SAD patterns were collected using a Gatan OneView camera. Energy-dispersed X-ray spectroscopy (EDX) data were collected using an SDD EDX detector.

Electrochemical tests. In order to investigate the electrochemical performance of Cu₃(HHTP)₂ as a cathode in zinc batteries, coin cells with a two-electrode configuration, which comprise a Cu₃(HHTP)₂ cathode and a Zn-film anode (100 μm in thickness), were assembled. The Cu₃(HHTP)₂ electrode was first prepared by making a slurry containing 60 wt % Cu₃(HHTP)₂, 20 wt % acetylene black, and 20 wt % poly(vinylidene difluoride) (PVdF) in 1-methyl-2-pyrrolidinon (NMP). The slurry was then cast onto stainless steel (SUS 304) foil, followed by drying at 70° C. in a vacuum oven. The mass loading of the active material in each electrode was 2 mg cm⁻². The electrolyte solution was 3 M zinc trifluoromethanesulfonate (Zn(CF₃SO₃)₂) in DI water. All cells were aged for 1 h prior to initiating electrochemical processes to ensure good soaking of the electrolyte solution into the electrodes. The cells were cycled in the voltage range of 0.5-1.3 V (vs. Zn/Zn²⁺). All measurements were taken at 25° C. using a battery tester (BST8-300-CST, MTI, USA). All galvanostatic measurements were taken at the constant current mode (no constant voltage steps). Cyclic voltammetry (CV) was carried out using coin cells with a two-electrode configuration, which comprise the Cu₃(HHTP)₂ cathode and the Zn film anode (Reference 600 potentiostat, Gamry Instruments, USA).

Characterization. For the characterization of Cu₃(HHTP)₂ at different charge and discharge states, the cells were opened and rinsed with DI water inside a glove-box. The morphology of powder and elementary analysis was carried out through field-emission scanning electron microscopy (FE-SEM, Hitachi S-4800) with implemented energy-dispersive X-ray spectroscopy (EDX, Oxford Aztec X-max 80 SDD EDS detector). The image acquired at a working distance of 7 mm with an electron beam energy of 20 kV and emission current of 20 μA.

Powder X-ray diffraction (PXRD, STOE STADI-P) with Cu-Kα1 radiation (λ=1.54056 Å) was measured through transmission geometry for crystal structure analysis by scanning in the 2θ range of 2°-90° with accelerating voltage and current of 40 kV and 40 mA. For the ex situ PXRD characterization of Cu₃(HHTP)₂ at different charge and discharge states, the cells were opened and rinsed with DI water inside a glove-box.

The oxidation states of electrodes were analyzed via X-ray photoelectron spectroscopy (XPS, Thermo scientific ESCALAB 250Xi). Each sample was dried under vacuum for 1 h prior to XPS measurements. For the ex situ XPS characterization of Cu₃(HHTP)₂ at different charge and discharge states, the cells were opened and rinsed with DI water inside a glove-box.

Synthesis and Characterization of Cu₃(HHTP)₂

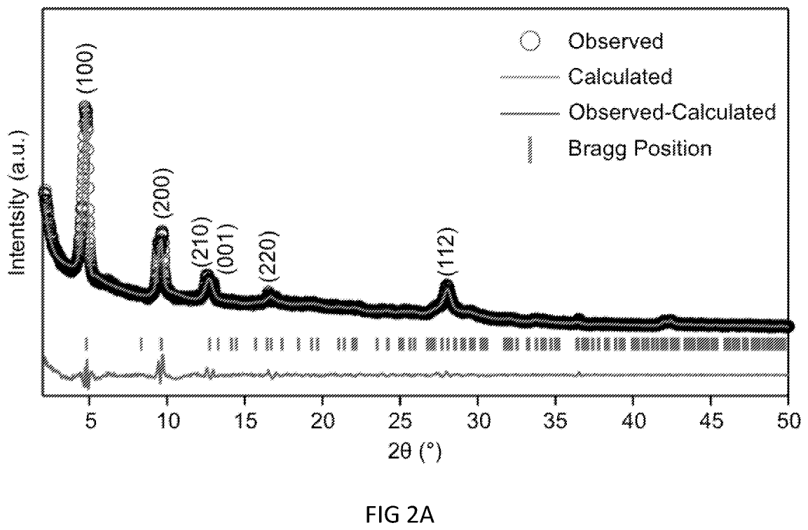

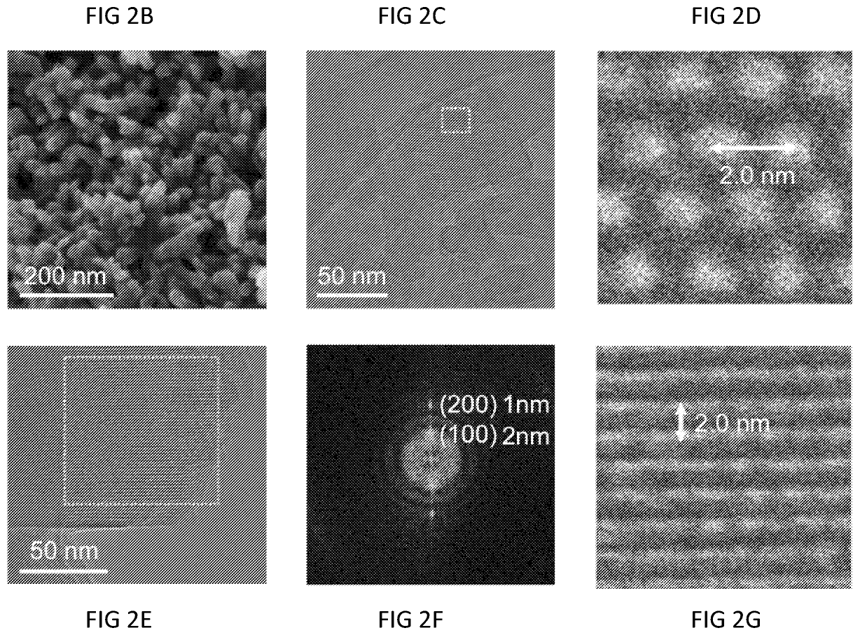

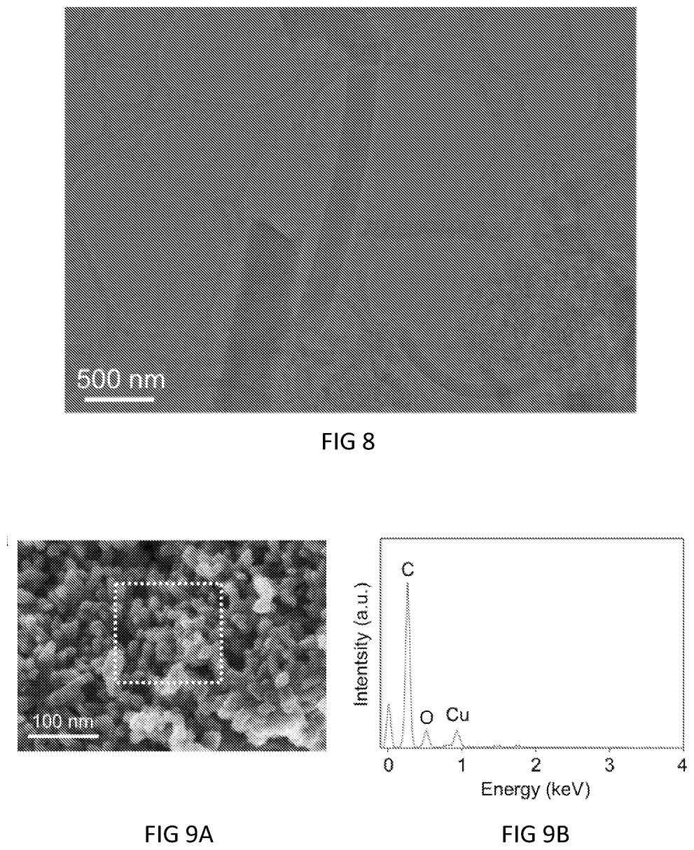

Cu₃(HHTP)₂ was synthesized as per the previously reported procedure²⁷. PXRD analysis confirmed that the synthesized Cu₃(HHTP)₂ comprises hexagonal 2D sheets stacked in a slipped-parallel configuration along the c axis (FIG. 1B)³²⁻³³. Cu₃(HHTP)₂ was indexed based on a hexagonal unit cell with the space group P6/mmm (FIG. 2A). The lattice parameters were calculated to be a=b=21.2 Å and c=6.6 Å with Rietveld refinement (Rₚ=3.41, R_{wp}=4.52, χ²=3.06). The morphology of Cu₃(HHTP)₂ was also investigated through field emission scanning electron microscopy (FE-SEM). As shown in FIG. 2B, the shape of Cu₃(HHTP)₂ is similar to that of the uniform rods of Ni₃(HHTP)₂²⁷. A TEM image also shows the one-dimensional (1D) nanorod structure of Cu₃(HHTP)₂ (FIG. 8). The length of Cu₃(HHTP)₂ nanorods extend a few micrometers with a diameter of around 20-500 nm (FIG. 2C and FIG. 8). In addition, a HR-TEM image (FIG. 2D) enlarged from the selected white area in FIG. 2C obviously shows large pores with a diameter of approximately 2.0 nm with a honeycomb arrangement along [001] view direction. An enlarged HR-TEM image (FIG. 2G) from the selected area in FIG. 2E shows a Cu₃(HHTP)₂ nanorod along [010] with a lattice distance of 2.0 nm for the (100) crystal plane. Fast Fourier transform (FFT) from the selected area (FIG. 2F) clearly indicates that Cu₃(HHTP)₂ nanorods have well developed (100) and (200) planes. These indicate that the synthesized Cu₃(HHTP)₂ is highly crystalline in nature with the [100] axis being the preferred orientation for 1D nanorods²⁷. These unique structures of the Cu₃(HHTP)₂ with the shape of 1D nanorods and large pores could facilitate the diffusion of Zn²⁺ ions during the discharge-charge process. In addition, scanning electron microscopy-energy dispersive X-ray spectroscopy (SEM-EDX) was used to verify the C, O, and Cu contents of the Cu₃(HHTP)₂ particles (FIGS. 9A-9B).

Electrochemical Performance of Cu₃(HHTP)₂

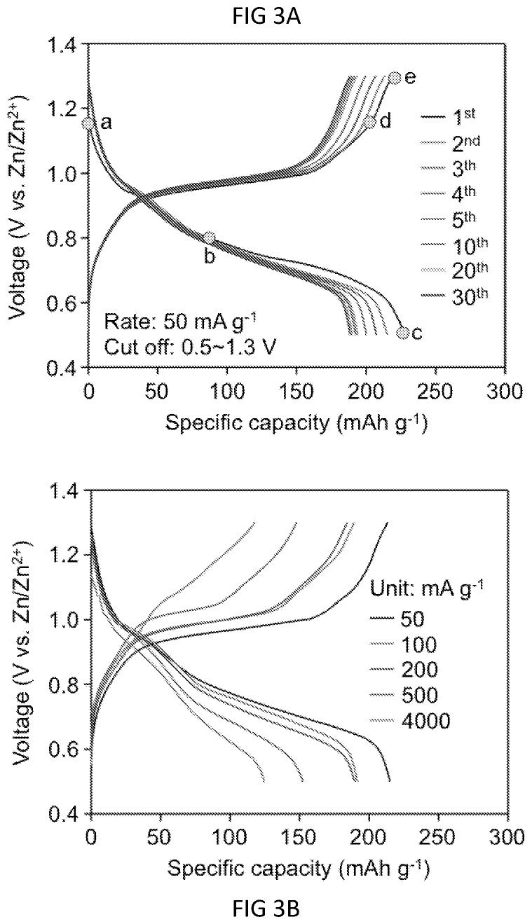

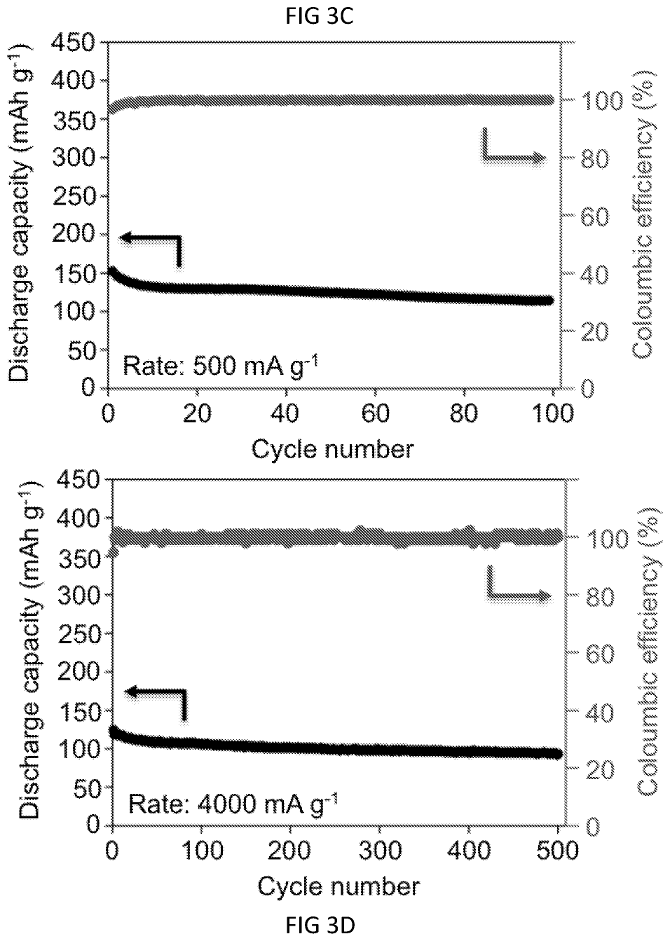

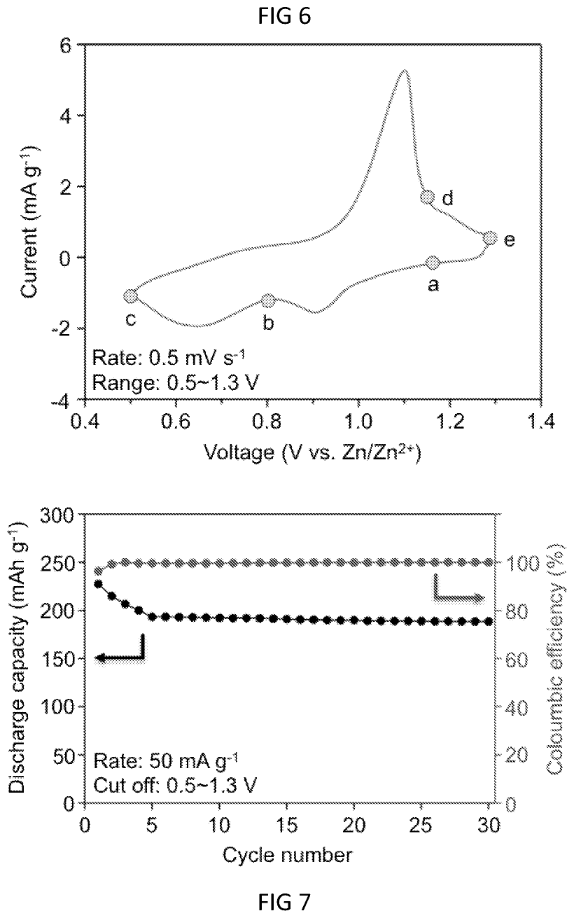

A cyclic voltammogram of Cu₃(HHTP)₂ thin film on SUS foil in 3.0 M aqueous solution of Zn(CF₃SO₃)₂ indicates that the Zn²⁺ insertion and extraction reaction is reversible (FIG. 6). The reaction of Zn²⁺ ions into/from the Cu₃(HHTP)₂ reversibly occurred at approximately 0.65 V/1.10 V and 0.90 V/1.21 V (vs. Zn/Zn²⁺), respectively. Galvanostatic tests reveal that this reversibility was reflected in the voltage profiles, with plateaus at the corresponding voltages (FIG. 3A). The first discharge plateau at approximately 0.90 V (vs. Zn/Zn²⁺) originated from the redox process between Cu²⁺ and Cu⁺. Furthermore, the second discharge plateau at 0.65 V (vs. Zn/Zn²⁺) may be attributed to the two-electron uptake process of the HHTP linkers. The detailed redox reaction mechanism is discussed in the upcoming sections. The initial reversible capacity was 228 mAh g⁻¹ at a rate of 50 mA g⁻¹, followed by a capacity of 215 mAh g⁻¹ in the 2^{nd} cycle, and the voltage profiles and capacity were retained for 30 cycles (FIG. 3A and FIG. 7). These reversible capacities are quite remarkable, providing some of the highest reported values for cathodes with open-framework structures, including Prussian Blue analogues³⁴⁻³⁶ that have been applied to aqueous rechargeable ZBs (Table 1).

TABLE 1
Comparison of rate performances of Cu₃(HHTP)₂ with reported
Prussian Blue analogue cathodes with high rate capabilities.

| | Operating | | |
|---|---|---|---|
| | Voltage | | |
| Cathodes | (V vs. Zn/Zn²⁺) | Specific Capacity | Ref. |
| Cu₃(HHTP)₂ | 0.97 | 228.0 mAh g⁻¹ at 50 mA g⁻¹ | This |
| | | 124.0 mAh g⁻¹ at 4000 mA g⁻¹ | work |
| ZnHCF | 1.70 | 65.4 mAh g⁻¹ at 60 mA g⁻¹ | 34 |
| | | 32.3 mAh g⁻¹ at 1200 mA g⁻¹ | |
| C-RZnHCF | 1.73 | 66.5 mAh g⁻¹ at 60 mA g⁻¹ | 35 |
| | | 29.3 mAh g⁻¹ at 1200 mA g⁻¹ | |
| CuHCF | 1.73 | 55.0 mAh g⁻¹ at 60 mA g⁻¹ | 36 |
| | | 42.5 mAh g⁻¹ at 600 mA g⁻¹ | |

To verify the role of the Cu₃(HHTP)₂ 2D structure with large pores on electrochemical performance, we conducted rate-capability tests. In our electrochemical tests, Cu₃(HHTP)₂ demonstrated excellent rate capability (FIG. 3B). The Cu₃(HHTP)₂ electrode exhibited capacities of 191.4, 189.3, 152.5, and 124.4 mAh g⁻¹ when the current density was increased by 2, 4, 10, and 80 times (100, 200, 500, and 4000 mA g⁻¹) from 50 mA g⁻¹. These results correspond to capacity retentions of 89.0%, 88.0%, 70.9%, and 57.9%, respectively, with respect to the initial capacity of 215.0 mAh g⁻¹. Moreover, the Cu₃(HHTP)₂ electrodes showed promising cycling stability. At a current density of 500 mA g⁻¹ (˜2 C), 75.0% of the initial capacity (152.5 mAh g⁻¹) was maintained after 100 cycles (FIG. 3C). Furthermore, at an extremely high current density of 4000 mA g⁻¹ (˜18 C), 75.0% of the initial capacity (124.4 mAh g⁻¹) was maintained after 500 cycles (FIG. 3D). This cyclability reflects the structural stability of Cu₃(HHTP)₂ during repeated (de)intercalation of the Zn²⁺ ions.

### Electronic States Analysis During Discharge-Charge

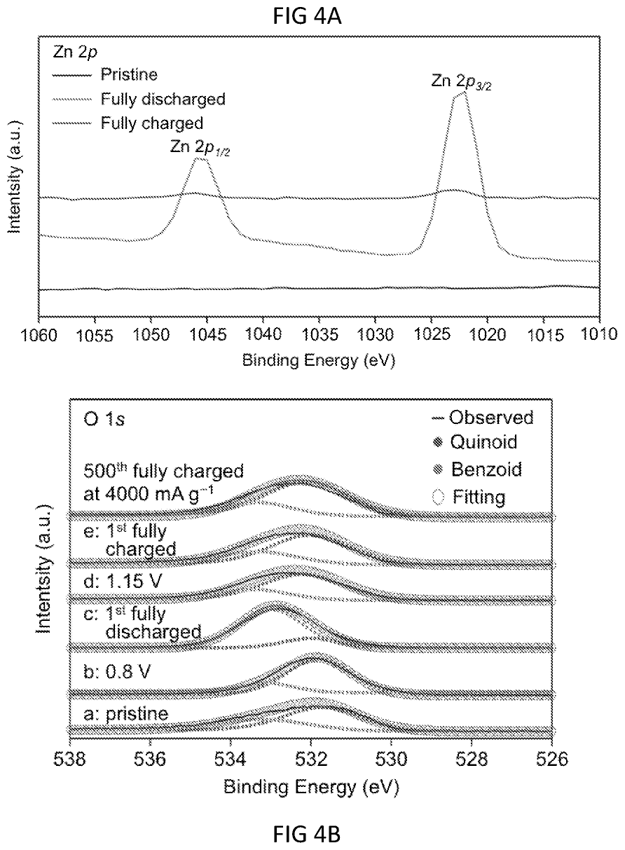

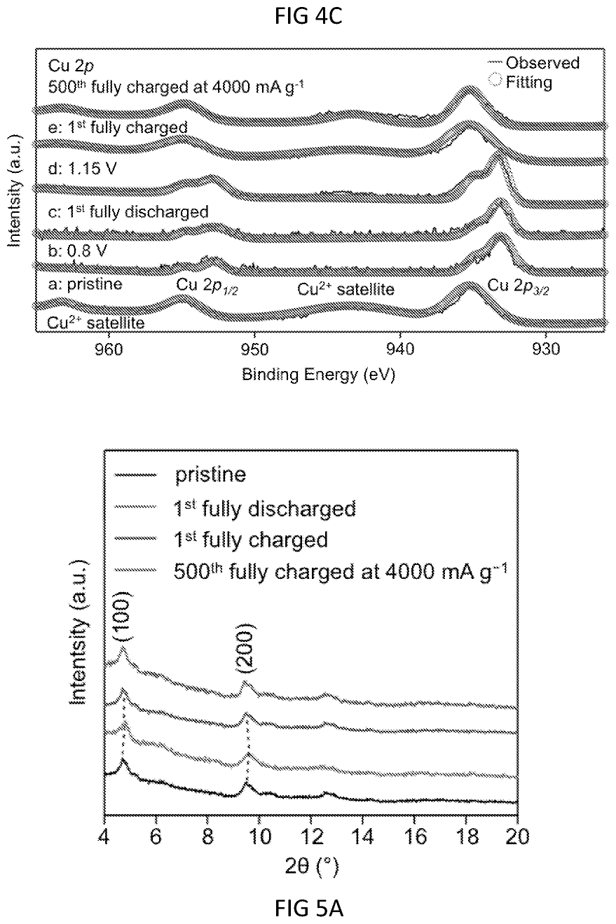

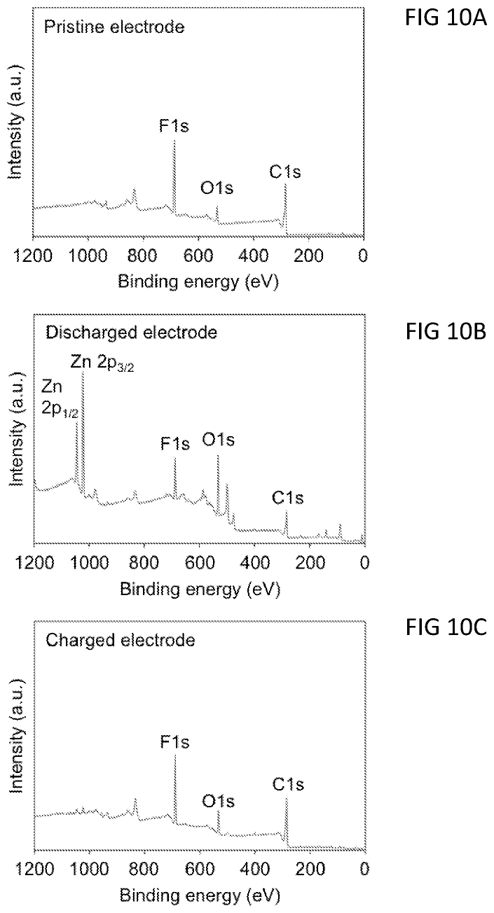

To investigate the changes in electronic states of Cu₃(HHTP)₂ during discharge-charge, X-ray photoelectron spectroscopy (XPS) was conducted on the Zn, O, and Cu elements. After inserting Zn²⁺ ions into the Cu₃(HHTP)₂, the Zn 2p peaks appear and disappear at the discharged and charged states, respectively (FIG. 4A and FIGS. 10A-10C); a consequence of the reversible insertion/extraction of Zn²⁺ into/from the Cu₃(HHTP)₂ cathodes. The quinoid peak at 532 eV shifted to a benzoid peak at 533 eV in the O is spectrum (FIG. 4B) while discharging from 0.8 V (point b in FIG. 3A) to a fully discharged state (point c in FIG. 3A). The shifted peaks returned to their original positions while charging from the fully discharged state (point c in FIG. 3A) to 1.15 V (point d in FIG. 3A). This shift reveals that the second plateau (FIG. 3A) that exists during the discharge process originates from the quinoid acting as a redox center. Based on these XPS results, we infer that the quinoid was involved in the redox reaction. Similarly, the presence of transition metals involved in the redox reaction in our system caused the peaks of Cu²⁺ satellites in the pristine state to disappear (FIG. 4C). The Cu 2p peaks were then split into lower binding energy peaks between the pristine state (point a in FIG. 3A) and 0.8 V (point b in FIG. 3A) in the Cu 2p spectrum (FIG. 4C). There was then no further shift in the Cu 2p peaks that lay between 0.8 V (point b in FIG. 3A) and 1.15 V (point d in FIG. 3A). As expected, the initial Cu 2p spectrum was fully recovered, including its original profiles, between 1.15 V (point din FIG. 3A) and the fully charged state (point e in FIG. 3A). From these changes in the Cu 2p peaks, the first plateau (FIG. 3A) that appears during the discharge process could be attributed to a partial redox reaction from Cu²⁺ to Cu⁺. Consequently, these XPS analyses suggest that both the quinoid and the copper in Cu₃(HHTP)₂ participated as redox centers during the discharge-charge process. The theoretical capacity of Cu₃(HHTP)₂ should be 197 mAh g⁻¹ when using quinoid as the redox centers (FIG. 1C) and inserting Zn²⁺ ions with two electrons. However, the initial capacity determined for Cu₃(HHTP)₂ is 228 mAh g⁻¹ (FIG. 3A), which reveals that these Cu₃(HHTP)₂ cathodes can obtain 2.3 electrons. In light of these XPS results, the additional discharge capacity of Cu₃(HHTP)₂ can be derived from the redox events of Cu. Furthermore, both peaks of O 1s and Cu 2p of the charged electrode after 500 cycles at a rate of 4000 mA g⁻¹ (FIGS. 4B and 4C) were almost similar to those of the pristine electrode, indicating that the redox reaction of Cu₃(HHTP)₂ is highly reversible.

### Structure Analysis During Discharge-Charge

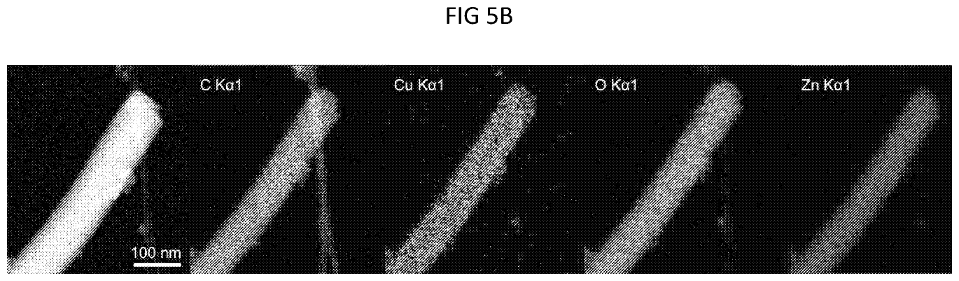

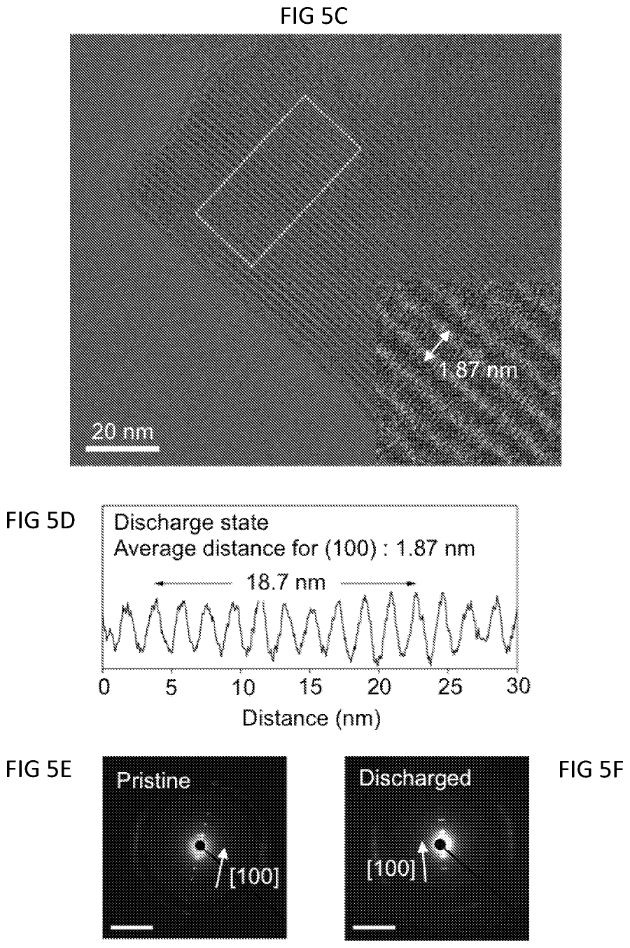

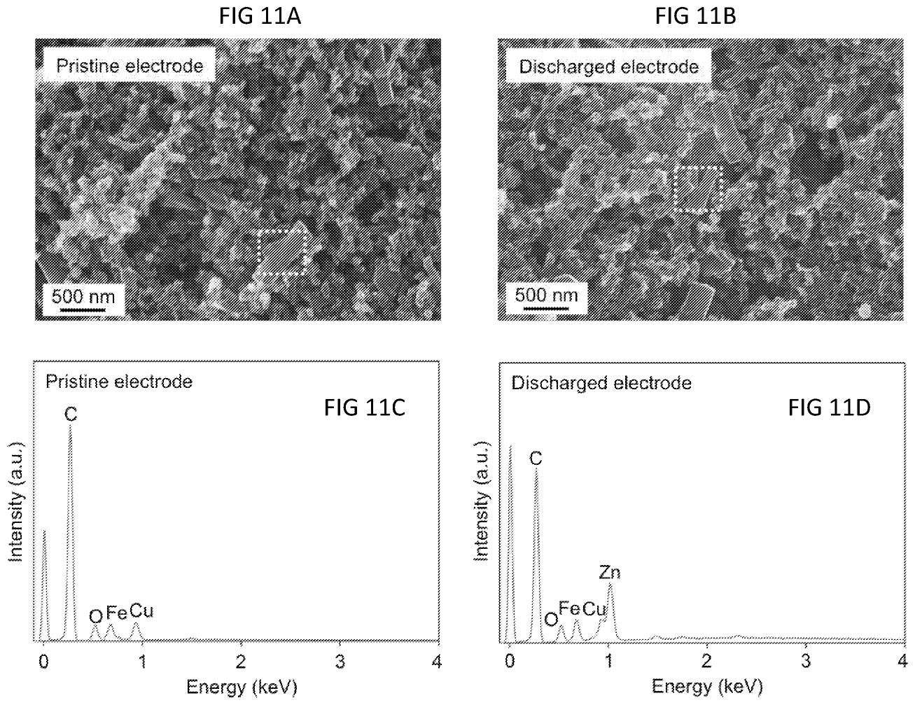

The PXRD patterns of Cu₃(HHTP)₂ in the discharged (inserting Zn²⁺ ions into Cu₃(HHTP)₂) electrode demonstrated that the (100) peak had a slight right-side shift from 4.70° to 4.85°, revealing that the pore size in Cu₃(HHTP)₂ decreased from 19.3 Å to 18.7 Å (FIG. 5A). It presumably indicates that inserting Zn²⁺ ions into Cu₃(HHTP)₂ decrease the pore size of Cu₃(HHTP)₂ owing to the electrostatic interaction between divalent Zn²⁺ cations and the oxygen anion of the host structure. After the charging process (extracting Zn²⁺ ions from Cu₃(HHTP)₂), the PXRD peaks in the charged electrode were fully returned to the position of original pristine state (FIG. 5A). In addition, after 500 cycles at a rate of 4000 mA g⁻¹, the PXRD patterns of Cu₃(HHTP)₂ were identical to that of the pristine state (FIG. 5A). This implies that the inserted Zn²⁺ ions only affect the pore size of the host structure and the structure of Cu₃(HHTP)₂ is robustly maintained when Zn²⁺ ions are inserted/extracted into/from Cu₃(HHTP)₂. Similarly, the morphology of the Cu₃(HHTP)₂ after Zn²⁺ ion insertion (FIGS. 11B and 11D) is almost the same as that of Cu₃(HHTP)₂ in a pristine state (FIGS. 11A and 11C). Consequently, our PXRD results obviously lead us to infer that the Zn²⁺ cations are accommodated in the large pores of the Cu₃(HHTP)₂, thus enabling high long-term stability while cycling at a high rate.

Confirmation of Inserting Zn²⁺ Ion into Pore Structure of Cu₃(HHTP)₂

The uniform insertion of Zn²⁺ into Cu₃(HHTP)₂ nonorods was confirmed through EDX chemical mapping (FIG. 5B) that shows uniform distribution of Zn over the entire electrode area at the fully discharged state. To more clearly elucidate the insertion of Zn²⁺ ions into the pore of Cu₃(HHTP)₂, the lattice parameter changes were analyzed with HR-TEM in the discharged state (FIG. 5C). Interestingly, after inserting Zn²⁺ ions into Cu₃(HHTP)₂ nanorods, the lattice distance of the (100) plane (inset of FIG. 5C and FIG. 5D) slightly decreased to 1.87 nm, which demonstrates the same tendency observed in the PXRD patterns (FIG. 5A). In addition, selected area diffraction patterns from pristine and discharged samples (FIGS. 5E and 5F) demonstrate that the (100) lattice distance decreased from 2.01(±0.01) nm to 1.90(±0.01) nm, in the consequent interaction of divalent cation, inserted in the pore, with the framework. Therefore, this result first verifies the evidence that Zn²⁺ ions are inserted into the pores in MOFs in a battery system.

### CONCLUSIONS

In summary, we first present a M₃(C₆(C₆H₂X₂)₃)₂ 2D conductive MOF M₃(C₆(C₆H₂X₂)₃)₂ active material that may be utilized as a cathodic material in the preparation of a rechargeable aqueous battery. The crystalline structure of Cu₃(HHTP)₂, with large pores and high electrical conductivity, provides a dramatically increased rate performance and cyclability compared to classical organic-based materials. Furthermore, our XPS results suggest that Cu₃(HHTP)₂ utilizes both copper and the quinoid as redox active sites, as a consequence of increasing the specific capacity of the material. Above all, our PXRD and TEM results elucidate that inserted Zn²⁺ ions are stored in the Cu₃(HHTP)₂ pores. These findings clearly indicate the potential of these cathodes for use in large-scale applications.

### REFERENCES

1. Dunn, B., Kamath, H. & Tarascon, J.-M. Electrical energy storage for the grid: A battery of choices. Science 334, 928-935 (2011).
2. Yang, Z. et al. Electrochemical energy storage for green grid. Chem. Rev. 111, 3577-3613 (2011).
3. Larcher, D. & Tarascon, J. M. Towards greener and more sustainable batteries for electrical energy storage. Nat. Chem. 7, 19-29 (2015).
4. Li, W., Dahn, J. R. & Wainwright, D. S. Rechargeable lithium batteries with aqueous electrolytes. Science 264, 1115-1118 (1994).
5. Luo, J.-Y., Cui, W.-J., He, P. & Xia, Y.-Y. Raising the cycling stability of aqueous lithium-ion batteries by eliminating oxygen in the electrolyte. Nat. Chem. 2, 760-765 (2010).
6. Kundu, D., Adams, B. D., Duffort, V., Vajargah, S. H. & Nazar, L. F. A high-capacity and long-life aqueous rechargeable zinc battery using a metal oxide intercalation cathode. Nat. Energy 1, 16119 (2016).
7. Pan, H. et al. Reversible aqueous zinc/manganese oxide energy storage from conversion reactions. Nat. Energy 1, 16039 (2016).
8. Zhang, N. et al. Rechargeable aqueous zinc-manganese dioxide batteries with high energy and power densities. Nat. Commun. 8, 405 (2017).
9. Hu, E. & Yang, X.-Q. Rejuvenating zinc batteries. Nat. Mater. 17, 480-481 (2018).
10. Wang, F. et al. Highly reversible zinc metal anode for aqueous batteries. Nat. Mater. 17, 543-549 (2018).
11. Zhao, Q. et al. High-capacity aqueous zinc batteries using sustainable quinone electrodes. Sci. Adv. 4 (2018).
12. Xu, C., Li, B., Du, H. & Kang, F. Energetic zinc ion chemistry: The rechargeable zinc ion battery. Angew. Chem. Int. Ed. 51, 933-935 (2012).
13. Lee, B. et al. Electrochemically-induced reversible transition from the tunneled to layered polymorphs of manganese dioxide. Sci. Rep. 4 (2014).
14. Lee, B. et al. Elucidating the intercalation mechanism of zinc ions into α-MnO₂ for rechargeable zinc batteries. Chem. Commun. 51, 9265-9268 (2015).
15. Xia, C., Guo, J., Li, P., Zhang, X. & Alshareef, H. N. Highly stable aqueous zinc-ion storage using a layered calcium vanadium oxide bronze cathode. Angew. Chem. Int. Ed. 57, 3943-3948 (2018).
16. Liang, Y. et al. Universal quinone electrodes for long cycle life aqueous rechargeable batteries. Nat. Mater. 16, 841 (2017).
17. Dawut, G., Lu, Y., Miao, L. & Chen, J. High-performance rechargeable aqueous Zn-ion batteries with a poly(benzoquinonyl sulfide) cathode. Inorg. Chem. Front. 5, 1391-1396 (2018).
18. Kundu, D. et al. Organic cathode for aqueous Zn-ion batteries: Taming a unique phase evolution toward stable electrochemical cycling. Chem. Mater. 30, 3874-3881 (2018).
19. Sheberla, D. et al. Conductive MOF electrodes for stable supercapacitors with high areal capacitance. Nat. Mater. 16, 220 (2016).
20. Feng, D. et al. Robust and conductive two-dimensional metal-organic frameworks with exceptionally high volumetric and areal capacitance. Nat. Energy 3, 30-36 (2018).
21. Park, J. et al. Stabilization of hexaaminobenzene in a 2D conductive metal-organic framework for high power sodium storage. J. Am. Chem. Soc. 140, 10315-10323 (2018).
22. Férey, G. et al. Mixed-valence Li/Fe-based metal-organic frameworks with both reversible redox and sorption properties. Angew. Chem. Int. Ed. 46, 3259-3263 (2007).
23. Aubrey, M. L. & Long, J. R. A dual-ion battery cathode via oxidative insertion of anions in a metal-organic framework. J. Am. Chem. Soc. 137, 13594-13602 (2015).
24. Zhang, Z., Yoshikawa, H. & Awaga, K. Monitoring the solid-state electrochemistry of Cu(2,7-AQDC) (AQDC=anthraquinone dicarboxylate) in a lithium battery: Coexistence of metal and ligand redox activities in a metal-organic framework. J. Am. Chem. Soc. 136, 16112-16115 (2014).
25. Wada, K., Sakaushi, K., Sasaki, S. & Nishihara, H. Multielectron-transfer-based rechargeable energy storage of two-dimensional coordination frameworks with non-innocent ligands. Angew. Chem. Int. Ed. 57, 8886-8890 (2018).
26. Sun, L. et al. Electrically conductive porous metalorganic frameworks. Angew. Chem. Int. Ed. 2016, 55, 3566 3579.
27. Hmadeh, M. et al. New porous crystals of extended metal-catecholates. Chem. Mater. 24, 3511-3513 (2012).
28. Chen, I-F. et al. Highly conductive 2D metalorganic framework thin film fabricated by liquid-liquid interfacial reaction using one-pot-synthesized benzenehexathiol. Langmuir 2018, 34, 15754-15762.
29. Cui, J. et al. An electroactive porous network from covalent metal-dithiolene links. Chem. Commun. 2014, 50, 3986-3988.
30. Sheberla, D. et al. High electrical conductivity in Ni₃(2,3,6,7,10,11-hexaiminotriphenylene)₂, a semiconducting metalorganic graphene analogue. J. Am. Chem. Soc. 2014, 136, 8859-8862.
31. Campbell, M. G. et al. Cu₃(hexaiminotriphenylene)₂: An electrically conductive 2D metalorganic framework for chemiresistive sensing. Angew. Chem. Int. Ed. 2015, 54, 4349-4352.
32. Campbell, M. G., Liu, S. F., Swager, T. M. & Dinc\check{a}, M. Chemiresistive sensor arrays from conductive 2D metal-organic frameworks. J. Am. Chem. Soc. 137, 13780-13783 (2015).
33. Miner, E. M., Wang, L. & Dinc\check{a}, M. Modular Modular O₂ electroreduction activity in triphenylene-based metal-organic frameworks. Chem. Sci. 9, 6286-6291 (2018).
34. Zhang, L., Chen, L., Zhou, X. & Liu, Z. Towards high-voltage aqueous metal-ion batteries beyond 1.5 V: the zinc/zinc hexacyanoferrate system. Adv. Energy Mater. 5, 1400930 (2015).
35. Zhang, L., Chen, L., Zhou, X. & Liu, Z. Morphology-dependent electrochemical performance of zinc hexacyanoferrate cathode for zinc-ion battery. Sci. Rep. 5, 18263 (2015).
36. Trócoli, R. & La Mantia, F. An aqueous zinc-ion battery based on copper hexacyanoferrate. ChemSusChem 8, 481-485 (2015).

1. A battery comprising:
(a) a cathode, the cathode comprising a M₃(C₆(C₆H₂X₂)₃)₂ active material, wherein M is selected from a late transition metal and X is selected from O, S, or NH;
(b) an anode; and
(c) an aqueous electrolyte, the aqueous electrolyte comprising a multivalent cationic charge carrier.

2. The battery of claim 1, wherein—
(i) the multivalent cationic charge carrier is selected from Zn²⁺, Mg²⁺, Ca²⁺, Sr²⁺, Ba²⁺, or Al³⁺,
(ii) M is selected from Cu, Co, Ni, or Pt; or
(iii) both (i) and (ii).

3. The battery of claim 2, the multivalent cation is Zn²⁺.

4. The battery of claim 1, wherein X is O.

5. The battery of claim 4, wherein M is Cu, Co, or Ni.

6. The battery of claim 5, wherein M is Cu.

7. The battery of claim 1, wherein X is S.

8. The battery of claim 7, wherein M is Co or Pt.

9. The battery of claim 1, wherein X is NH.

10. The battery of claim 1, wherein M is Cu or Ni.

11. The battery of claim 1, wherein the cathode further comprises a binder, an electron-conducting material, a current collector, or any combination thereof.

12. The battery of claim 1, further comprising a separator.

13. The battery of claim 1, wherein the battery is rechargeable.

14. The battery of claim 1, wherein the anode is a Zn anode.

15. A method for preparing a battery, the method comprising
(a) providing a cathode comprising a M₃(C₆(C₆H₂X₂)₃)₂ active material, wherein M is selected from a late transition metal and X is selected from O, S, or NH an anode,
(b) providing an aqueous electrolyte, the aqueous electrolyte comprising a multivalent cationic charge carrier, and
(c) assembling the cathode, the aqueous electrolyte, and an anode, thereby preparing the battery.

16. The method of claim 15, wherein providing the cathode comprises preparing a slurry comprising the active material, depositing the slurry onto a substrate, and drying the slurry.

17. The method of claim 16, wherein the slurry further comprises a binder, an electron-conducting material, a solvent, or any combination thereof.

18. The method of claim 16, wherein the substrate is a current collector.

19. The method of claim 15 further comprising providing a separator, wherein the separator is assembled with the cathode, the aqueous electrolyte, and the anode to prepare the battery.

20. The method of claim 15, wherein—
(i) the multivalent cationic charge carrier is selected from Zn²⁺, Mg²⁺, Ca²⁺, Sr²⁺, Ba²⁺, or Al³⁺;
(ii) M is selected from Cu, Co, Ni, or Pt; or
(iii) both (i) and (ii).
